(19) United States
(12) Patent Application Publication
(10) Pub. No.: US 2013/0220301 A1
(43) Pub. Date: Aug. 29, 2013

(54) GAS BURNER SYSTEM FOR GAS-POWERED COOKING DEVICES

(71) Applicants: Atul Saksena, Troy, OH (US); Timothy L. Cupp, Hillsboro, OH (US); Jeffrey L. Frock, Troy, OH (US); Larry W. Lyons, Hillsboro, OH (US)

(72) Inventors: Atul Saksena, Troy, OH (US); Timothy L. Cupp, Hillsboro, OH (US); Jeffrey L. Frock, Troy, OH (US); Larry W. Lyons, Hillsboro, OH (US)

(21) Appl. No.: 13/408,678

(22) Filed: Feb. 29, 2012

(51) Int. Cl. A47J 27/16; F23N 1/02

(52) U.S. Cl. 126/377.1; 126/369; 126/20; 431/12; 431/6

(57) ABSTRACT

A food cooking device includes a cooking structure defining a volume for receiving food product to be cooked, and a heating arrangement for heating food product within the volume. The heating arrangement includes a gas burner system that includes a blower and fuel gas flow feed device arranged such that operation of the blower draws in ambient air and the flow of ambient air through the blower in turn draws fuel gas from the fuel gas flow control device such that a ratio of fuel gas to ambient air remains substantially the same regardless of blower speed. A burner is connected to receive the fuel gas and ambient air mixture from the blower. A controller is connected for controlling blower speed, the controller configured to vary the blower speed between at least two different non-zero blower speeds.

### TECHNICAL FIELD

The present application relates generally to steam ovens and steam heated kettles used for cooking food products, and more particularly to a gas burner control system for such ovens and kettles.

### BACKGROUND

Steam cooking systems have been successfully employed by restaurants, hospitals and other food service operations to prepare quickly and conveniently large quantities of food. Steam ovens can utilize electric or gas heating system to heat water to generate the steam for cooking. In the case of gas heating systems, conventional systems utilize a power burner that runs at one firing rate (i.e., rate of fuel gas moved through the burner) and requires either an elevation kit (containing a different gas valve, orifice or combination of the two) or re-setting of burner parameters for use at different elevations. Similarly, in the case of gas heating systems used for steam cooking kettles, the conventional systems utilize a single firing rate and require kits or adjustments for use at different elevations. In the case of both types of cooking devices, a change in air flow will typically cause a variation in the fuel gas-air mixture ratio, which can result in inefficient combustion.

It would be desirable to provide a gas burner system that provides variable firing rates and eliminates the need for use of elevation kits.

### SUMMARY

In one aspect, a food cooking device includes a cooking structure defining a volume for receiving food product to be cooked, and a heating arrangement for heating food product within the volume. The heating arrangement includes a gas burner system that includes a blower and fuel gas flow feed device arranged such that operation of the blower draws in ambient air and the flow of ambient air through the blower in turn draws fuel gas from the fuel gas flow control device such that a ratio of fuel gas to ambient air remains substantially the same regardless of blower speed. A burner is connected to receive the fuel gas and ambient air mixture from the blower. A controller is connected for controlling blower speed, the controller configured to vary the blower speed between at least two different non-zero blower speeds.

In one embodiment, the fuel gas flow feed device is formed by a zero pressure governor. An outlet of the zero pressure governor may be connected to a plate arrangement that is mounted proximate to an inlet opening of a housing of the blower. An ambient air flow path may defined between the plate arrangement and the blower housing for permitting air to be drawn into the inlet opening of the housing during operation of the blower, and a fuel flow path structure may extend from the plate arrangement through the inlet opening and into the housing of the blower.

The heating arrangement may further include an igniter associated with the burner and a controller connected for controlling blower speed and for controlling the igniter. The controller may be configured so that during burner start-up the blower is initially operated at a combustion start-up speed that is less than full speed and during which the igniter is operated to initiate combustion. The controller may be configured so that during burner start-up the blower is operated at the combustion start-up speed for a set time period and after the set time period the blower is operated at a higher speed.

In one embodiment, the cooking structure may be a kettle and the heating arrangement may be associated with a jacket surrounding a lower portion of the kettle.

In another embodiment, the cooking structure may be an oven housing defining a cooking chamber volume that is accessible via a movable door, and the heating arrangement may be associated with a steam generator unit that is connected to feed steam to the cooking chamber volume.

In one implementation of the preceding embodiment, the oven housing may be a first oven housing and the cooking chamber volume may be a first cooking chamber volume, and the food cooking device includes a second oven housing defining a second cooking chamber volume. The steam generator is connected to feed steam to the second cooking chamber volume. A controller is connected for controlling blower speed and configured such that when only the first cooking chamber calls for steam the blower is operated at a first speed and when both the first cooking chamber and the second cooking chamber call for steam the blower is operated at a second speed that is higher than the first speed.

In another aspect, a food cooking apparatus includes a cooking structure defining a volume for receiving food product to be cooked. A heating arrangement for heating food product within the volume uses a gas burner system that includes a blower and a zero pressure governor having an inlet receiving fuel gas and an outlet for the fuel gas, the outlet connected to a flow path that extends into the blower. An ambient air baffle arrangement is positioned alongside the blower and defines a flow path for permitting ambient air to flow into the blower. A gas burner is connected to receive the fuel gas and ambient air mixture from the blower. Ambient air flow into and through the blower pulls fuel gas through the zero pressure governor and into the blower for mixing with the ambient air, and when the blower is not operating fuel gas does not flow through the outlet of zero pressure governor. A controller is connected for controlling blower speed, the controller configured to vary the blower speed between at least two different non-zero blower speeds.

In yet another aspect, a method of controlling heating in a gas-powered cooking device involves: utilizing a blower and fuel gas flow feed device arrangement in which the operation of the blower draws in ambient air and the flow of ambient air through the blower in turn draws fuel gas from the fuel gas flow control device, the blower mixing the ambient and fuel gas for delivery to a burner positioned to heat water in one of a cooking kettle jacket or a steam generator of a steam oven; operating the blower at a first speed to achieve a first firing rate at the burner; operating the blower at a second speed to achieve a second firing rate at the burner, the second speed at least twenty percent greater than the first speed; wherein a fuel gas to ambient air ratio at the first firing rate is substantially the same as a fuel gas to ambient air ration at the second firing rate.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a partially exploded perspective of a steam cooking kettle;

FIG. 2 is cross-section of the kettle of FIG. 1;

FIG. 3 is an exploded perspective of the gas flow assembly of the cooking kettle of FIG. 1;

FIG. 4 is an exploded perspective of an alternate embodiment of a gas flow assembly; and

FIG. 5 is a schematic cross-section of a steam cooking system with a steam generator incorporating the gas flow assembly of FIG. 4.

### DETAILED DESCRIPTION

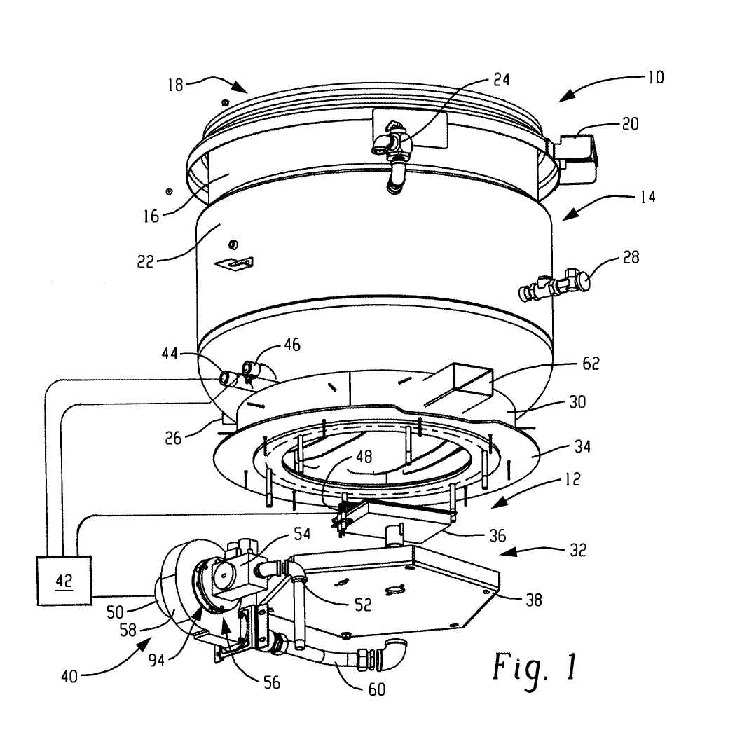

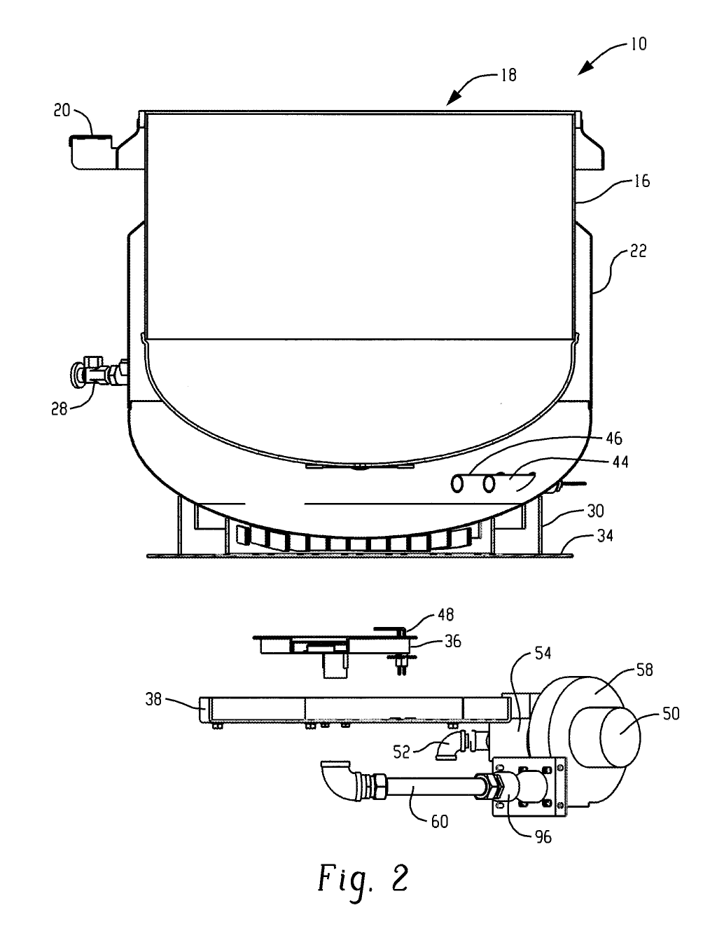

Referring to FIGS. 1 and 2, a steam cooking kettle system 10 is shown in partially exploded view with heating system 12 at the bottom of the kettle arrangement 14. The kettle arrangement 14 includes an inner kettle structure 16 with an open top 18 for receiving food product. The internal space of the kettle structure defines a chamber or volume for receiving food that is to be cooked. The top may be closed by a lid assembly (not shown) that attaches to a lid assembly bracket 20. The lower part of the kettle structure 16 includes a surrounding jacket 22 that forms a space that holds water to be heated. The water in the jacket is boiled, condenses on the outer surface of the kettle structure 16 and transfers heat to the kettle structure for heating food product contained within the kettle structure 16. In one example, the kettle jacket may be rated for up to 50 psi operation, but variations are possible. A water inlet pipe 24 and water outlet 26 are provided on the jacket for filling and emptying of the jacket space. A draw off valve unit 28 extends through the jacket 22 and the kettle structure 16 to enable liquid food product to be dispense from the kettle structure via the draw off valve unit.

The heating system 12 connects to the bottom of the jacket 22 and includes an cylindrical housing 30 which may, for example, be welded to the jacket 22 to define a heating space below the jacket. The heating space may include heat transfer structure (e.g., flow passages and/or fins or other structure) mounted to the exterior surface of the jacket to increase heat transfer to the jacket). A burner system 32 mounts to a plate structure 34 at the bottom of the housing 30 and includes a flat burner unit 36, a cover plate 38 and a gas flow assembly 40. A controller 42 of the burner system may be connected to each of a temperature and pressure sensors 44 and 46 located within the jacket space for detecting internal temperature and pressure of the space, a thermocouple probe and spark or other type igniter arrangement 48 mounted on the burner unit 36 and a blower motor 50 of the gas flow assembly 40.

A fuel gas input pipe 52 delivers fuel gas (e.g., natural gas, propane or butane-air) to a zero pressure gas governor 54 which in turn is connected to an orifice and air baffle plate assembly 56 that is mounted to the blower housing 58. An output pipe 60 from the blower delivers a fuel gas and air mixture to the burner unit 36 for combustion. The housing 30 includes a combustion gas take-off outlet 62 for exhausting the combustion gases. The outlet 62 is typically connected to a building exhaust flue (not shown) at the installation site.

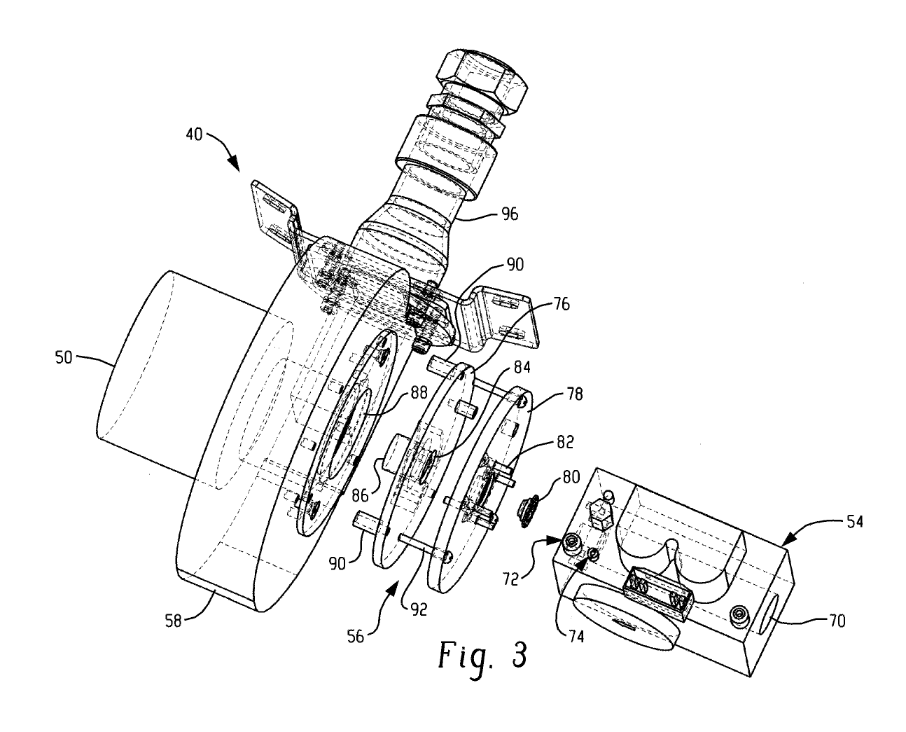

Referring now to FIG. 3, an exploded view of the gas flow assembly 40 is shown. The zero pressure governor 54 includes an inlet 70 and outlet 72 and is configured to provide a zero pressure fuel gas source at the outlet 72. That is, notwithstanding the typical pressure of the gas provided to the inlet 70 from whatever the fuel source, the outlet 72 has zero or substantially zero gas pressure relative to the ambient air pressure, meaning that gas will not flow through the governor 54 and out of the outlet 72 unless the flow is induced by a pull or suction at the outlet side of the governor 54. By way of example, a suitable zero pressure governor is part no. GB-WND 055 D01 available from Karl Dungs Inc., but alternative governor units could be used. The illustrated governor includes a variable internal orifice the size of which can be adjusted by way of an adjustment screw 74. The internal orifice may be adjusted in accordance with type of fuel gas being used (e.g., propane on the one hand defining one orifice size and natural gas or butane-air defining another orifice size).

The orifice and air baffle plate assembly 56 at the output side of the governor includes an air baffle plate 76 and an orifice plate 78. The orifice plate 78 includes a central opening that aligns with an orifice unit 80 that acts to limit the possible gas flow out of the governor 54, and also includes mounts 82 (e.g., screws) projecting from its surface and which fit into corresponding openings in the side of the governor for the purpose of mounting the governor adjacent the plate 78 so that all fuel gas flowing from the outlet 72 of the governor is delivered through the orifice of orifice unit 80. When assembled, the orifice plate 78 lies adjacent the air baffle plate 76 and the orifice unit 80 is sandwiched between and held by the plates so that fuel gas passing through the orifice unit 80 must pass through a central opening 84 of the air baffle plate 76. The opening 84 delivers the fuel gas to a protruding flow tube structure 86. When assembled, the tube 86 projects into a side opening 88 of the blower housing 58 so that the fuel gas is delivered into the housing. The air baffle plate 76 also includes a set of stand-off posts 90. Screws 92 pass through the posts 90 and secure the orifice plate 78 and air baffle plate 76 in position aside the blower housing 58, with the plate 78 held adjacent the plate 76. The posts hold the plate 76 at a defined spacing from the blower housing to define an ambient air path 94 (FIG. 1) to the side opening 88.

In operation, when the blower is operated ambient air is drawn into the path 94, through the side opening 88 into the blower housing and is then pushed through the blower housing outlet to piping 96, which in turn connects to the pipe 60 of FIG. 1. The flow of ambient air along this path creates a suction or pull effect back through the tube 86, orifice unit 80 and to the governor outlet 72 so that fuel gas is also pulled through the governor 56 and delivered into the blower housing 58 for mixing with the ambient air, thereby creating an air-gas mixture that is delivered to the burner for combustion. Notably, the mass of fuel gas drawn through the governor is proportional to the mass of the ambient pulled into the blower housing.

Thus, with suitable sizing and positioning of the burner system components to produce a desired air-gas ratio at a given blower speed, that air-gas ratio will also be maintained at different blower speeds. Specifically, if the blower is operated slower causing less ambient air to be drawn in, the suction effect at the governor outlet will be lower causing less fuel gas to be drawn in. Likewise, if the blower is operated faster causing more ambient air to be drawn in, the suction effect at the governor outlet will be higher causing more fuel gas to be drawn in. This arrangement provides a system that automatically accounts for different elevations. At higher altitudes where the density of ambient air is lower, the mass of air drawn into the blower will be lower (as compared to identical blower speed at lower elevation) and, likewise, the mass of fuel gas drawn through the governor will be lower, maintaining substantially the same air-gas ratio as between the different elevations.

This arrangement also provides potential advantages in terms of burner system control for the kettle. For example, the controller 42 may be configured (e.g., programmed or otherwise) to implement a defined burner start-up routine as follows. The blower is operated at forty percent (40%) of full speed for the purpose of initial start-up, during which the igniter is operated to initiate combustion. Once the thermocouple detects good combustion, or after a set time period (e.g., between 10 and 20 seconds), the blower is transitioned to one-hundred percent (100%) speed in order to heat up the kettle. In some embodiments, once operating pressure and/or temperature are reached within the jacket (e.g., as indicated by sensors 44, 46), the blower speed may be reduced to a lower speed suited for maintaining such pressure and temperature, avoiding any need to turn the burner off entirely. The blower speed effectively defines the firing rate for the system. The controller could also be configured with a stored idle speed that, for example, does not boil the water within the jacket, but maintains the water at a high temperature so as to be ready to produce steam quickly when necessary. The kettle system could also have different cooking modes with different firing rates. For example, in a simmer mode the blower speed (and therefore the firing rate) may be a stored, defined speed (e.g., stored in memory of the controller) that is lower than the blower speed for standard cooking.

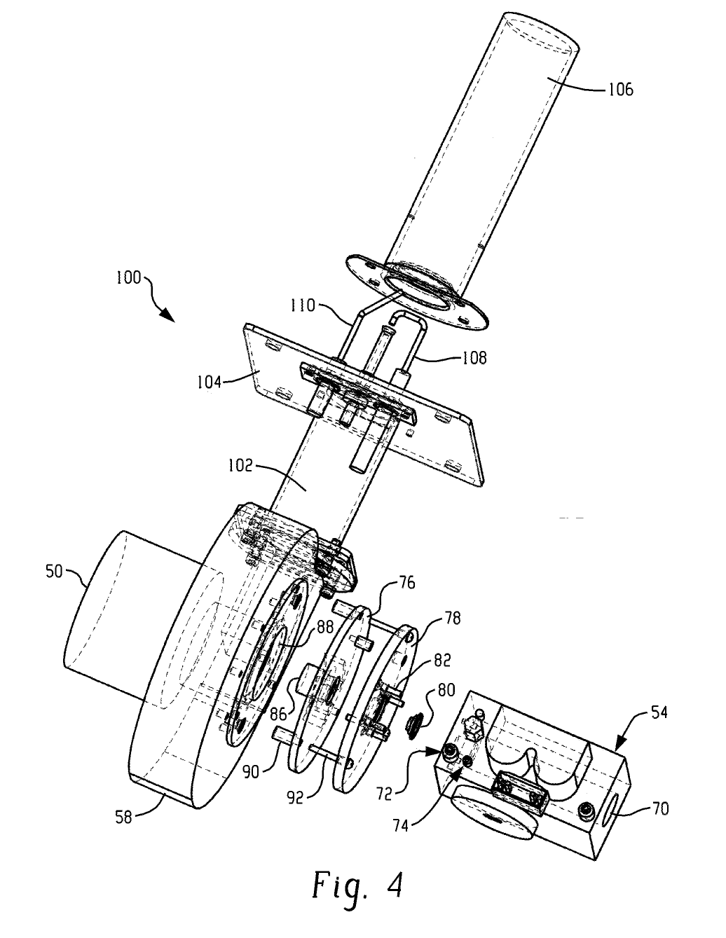

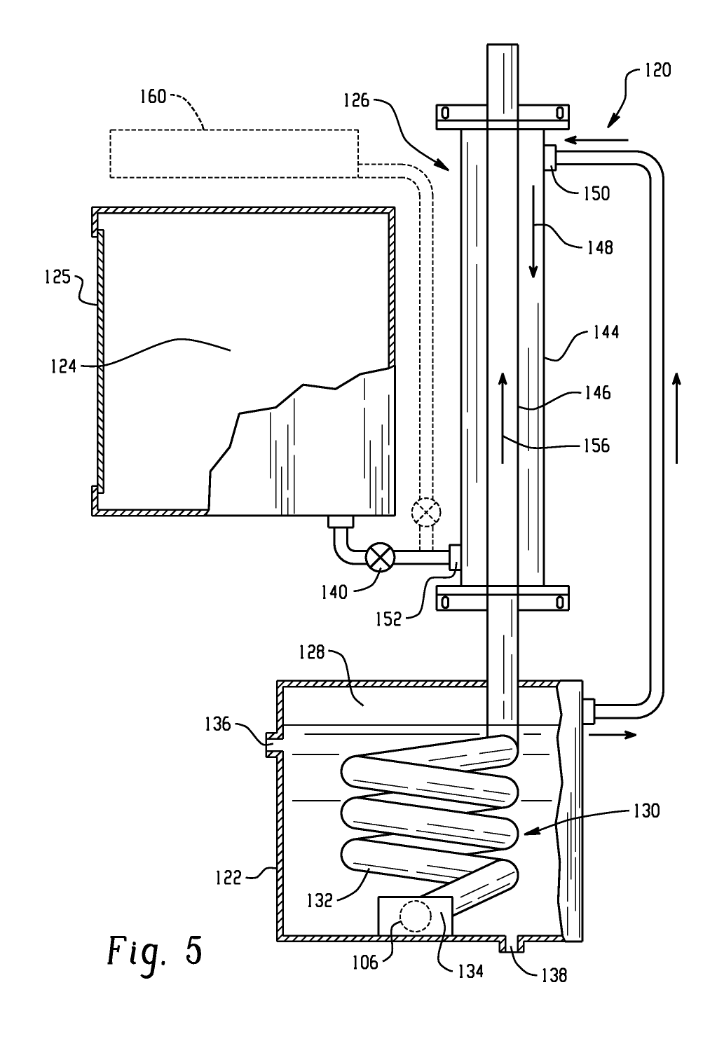

Referring now to FIG. 4, an exploded view of another gas flow assembly 100 is shown. The assembly 100 includes many similar components to the embodiment of FIG. 3 as shown by the similar numbering. However, in the embodiment of FIG. 4, the outlet of blower housing 58 connects to a tubular flow pipe 102, which in turn is connected to a burner mount plate 104. A tubular burner 106 (e.g. a mesh burner) is secured to the plate 104 via fasteners. The plate 104 also holds a spark igniter arrangement 108 and a thermocouple 110 which extend into the tubular burner 106 when in fully assembled configuration. The operation of assembly 100 is similar to that described above for assembly 40, except for the configuration of the burner. In this regard, and with reference to FIG. 5, the gas flow assembly 100 may be suitable for use in connection with, for example, a low pressure steam cooker 120 that includes a steam generator 122 for generating steam and a cooking chamber 124 that is in communication with the steam generator. The cooking chamber 124 is a volume that receives food to be cooked and is formed by an insulated housing with a door 125 movable between open and closed conditions for access. The steam generator 122 includes a heating chamber 128 where steam is generated and a steam superheater 126 capable of superheating the steam generated in the heating chamber under relatively low pressure conditions.

Disposed within the heating chamber 128 is a gas heat exchanger 130 in the form of a submerged heat exchanger tube. As shown, heat exchanger 130 includes a helical portion 132, however, any suitable design can be used. The heat exchanger 130 is connected to a burner box 134 into which the tubular burner 106 of the FIG. 4 assembly is inserted (e.g., in a horizontally extending manner). Heat exchanger 130 is located in the heating chamber 128 such that it can be in a heat exchange relationship with water disposed therein. While the illustrated heat exchange relationship with the water is via submersion of the heat exchanger, it is possible that hot gas could pass through ducts that are not submerged, such as ducts that run along the exterior wall of the heating chamber 128. The heating chamber 128 includes an inlet 136 for ingress of water into the heating chamber from a water source (not shown) and an outlet 138 for egress of water from the heating chamber (as when the chamber is to be drained). A valve (not shown) controls water flow into the heating chamber, e.g., to maintain a desired water level within the heating chamber 128 during steam production. Disposed between the steam superheater 126 and cooking chamber 124 is a valve 140 that controls the flow rate of superheated steam into the cooking chamber.

Steam superheater 126 includes an outer tube 144 and an inner tube 146 disposed within the outer tube. Outer tube 144 includes an inlet coupling 150 associated with a steam outlet of the heating chamber 18 and an outlet coupling 152 associated with the cooking chamber 14. Inner tube 146 forms part of the exhaust stack of the steam generator and includes a gas inlet fluidly connected to the heat exchanger 130 and an exhaust outlet for the venting of combustion gases. Inner tube 146 is concentrically arranged within outer tube 144 to form a steam passageway 148 between the inner and outer tubes and about the periphery of the inner tube and an exhaust passageway 156 within the inner tube.

Operation of a steam cooking system such as that of FIG. 5 is more fully described in U.S. Pat. No. 8,111,072, which is incorporated herein by reference. It is also recognized that the gas burner system could be utilized in other steam cooking oven configurations. For example, the steam generator 122 could be connected to feed steam to one or both of steam cooking chamber 124 and another steam cooking chamber 160 (represented in dashed line form only in FIG. 5). Regardless of the exact configuration, the controller for the oven may be configured (e.g., programmed or otherwise) to implement a defined start-up routine, such as that described above, in which the blower is operated at a reduced speed (e.g., 30-50% of standard full speed) for the purpose of initial start-up, during which the igniter 108 is operated to initiate combustion. Once the thermocouple 110 detects good combustion, or after a set time period (e.g., between 10 and 20 seconds), the blower is transitioned to standard full speed (e.g., 100% speed) in order to quickly heat water within the steam generator to start producing steam. Once steam is being produced, the blower speed can be reduced and/or varied according to steam needed. For example, if only one steam chamber 124 or 160 is calling for steam, the controller may operate the blower at only sixty percent of standard speed. On the other hand, if both steam chambers 124 and 160 are calling for steam, the controller may operate the blower at eight percent or one-hundred percent speed to produce more steam. An idle speed could also be provided as described above in connection with the kettle.

Again, the configuration of the gas flow assembly 100, as in the case of assembly 40, and particularly the arrangement in which the fuel gas and ambient air ratio is maintained substantially constant regardless of blower speed (e.g, even when the difference in blower speed is significant, such as 25% or more) or density of ambient air, is considered advantageous. The need for elevation kits can, in most instances, be eliminated and the firing rate of the system can be varied without adversely affecting combustion efficiency, enabling the system to meet any applicable CO2 output limits regardless of the firing rate.

It is to be clearly understood that the above description is intended by way of illustration and example only and is not intended to be taken by way of limitation. Other changes and modifications could be made.

What is claimed is:

1. A food cooking device, comprising:
a cooking structure defining a volume for receiving food product to be cooked;
a heating arrangement for heating food product within the volume, the heating arrangement comprising a gas burner system that includes:
a blower and fuel gas flow feed device arranged such that operation of the blower draws in ambient air and the flow of ambient air through the blower in turn draws fuel gas from the fuel gas flow control device such that a ratio of fuel gas to ambient air remains substantially the same regardless of blower speed;
a burner connected to receive the fuel gas and ambient air mixture from the blower; and
a controller connected for controlling blower speed, the controller configured to vary the blower speed between at least two different non-zero blower speeds.

2. The food cooking device of claim 1 wherein the fuel gas flow feed device comprises a zero pressure governor.

3. The food cooking device of claim 2 wherein an outlet of the zero pressure governor is connected to a plate arrangement that is mounted proximate to an inlet opening of a housing of the blower.

4. The food cooking device of claim 3 wherein an ambient air flow path is defined between the plate arrangement and the blower housing for permitting air to be drawn into the inlet opening of the housing during operation of the blower, and a fuel flow path structure extends from the plate arrangement through the inlet opening and into the housing of the blower.

5. The food cooking device of claim 2 wherein the zero pressure governor includes an adjustment mechanism enabling size of an internal orifice of the governor to be varied based upon fuel gas type.

6. The food cooking device of claim 1 wherein the heating arrangement further includes:
an igniter associated with the burner;
the controller connected for controlling the igniter, the controller configured so that during burner start-up the blower is initially operated at a combustion start-up speed that is less than full speed and during which the igniter is operated to initiate combustion.

7. The food cooking device of claim 6 wherein the controller is configured so that during burner start-up the blower is operated at the combustion start-up speed for a set time period and after the set time period the blower is operated at a higher speed.

8. The food cooking device of claim 1 wherein the cooking structure is a kettle and the heating arrangement is associated with a jacket surrounding a lower portion of the kettle.

9. The food cooking device of claim 1 wherein the cooking structure is an oven housing defining a cooking chamber volume that is accessible via a movable door, and the heating arrangement is associated with a steam generator unit that is connected to feed steam to the cooking chamber volume.

10. The food cooking device of claim 9 wherein the oven housing is a first oven housing and the cooking chamber volume is a first cooking chamber volume, the food cooking device includes a second oven housing defining a second cooking chamber volume, the steam generator is connected to feed steam to the second cooking chamber volume, the food cooking device further including a controller connected for controlling blower speed and configured such that when only the first cooking chamber calls for steam the blower is operated at a first speed and when both the first cooking chamber and the second cooking chamber call for steam the blower is operated at a second speed that is higher than the first speed.

11. The food cooking device of claim 1 wherein the heating arrangement includes a volume that contains water and that can be heated to produce steam for, one blower speed corresponds to a steam production speed and another blower speed corresponds to an idle speed.

12. A food cooking apparatus, comprising:
a cooking structure defining a volume for receiving food product to be cooked;
a heating arrangement for heating food product within the volume, the heating arrangement comprising a gas burner system that includes:
a blower;
a zero pressure governor having an inlet receiving fuel gas and an outlet for the fuel gas, the outlet connected to a flow path that extends into the blower;
an ambient air baffle arrangement positioned alongside the blower and defining a flow path for permitting ambient air to flow into the blower;
a gas burner that is connected to receive the fuel gas and ambient air mixture from the blower; and
a controller connected for controlling blower speed, the controller configured to vary the blower speed between at least two different non-zero blower speeds.

13. The food cooking apparatus of claim 12 wherein ambient air flow into and through the blower pulls fuel gas through the zero pressure governor and into the blower for mixing with the ambient air, and when the blower is not operating fuel gas does not flow through the outlet of zero pressure governor.

14. The cooking apparatus of claim 13 wherein the heating arrangement further includes:
an igniter associated with the gas burner;
the controller connected for controlling the igniter, the controller configured so that during burner start-up the blower is initially operated at a combustion start-up speed that is less than full speed and during which the igniter is operated to initiate combustion.

15. The food cooking apparatus of claim 14 wherein the controller is configured so that during burner start-up the blower is operated at the combustion start-up speed for a set time period and after the set time period the blower is operated at a higher speed.

16. The food cooking apparatus of claim 12 wherein the cooking structure is a kettle and the heating arrangement is associated with a jacket surrounding a lower portion of the kettle.

17. The food cooking apparatus of claim 12 wherein the cooking structure is an oven housing defining a cooking chamber volume that is accessible via a movable door, and the heating arrangement is associated with a steam generator unit that is connected to feed steam to the cooking chamber volume.

18. A method of controlling heating in a gas-powered cooking device, the method comprising:
utilizing a blower and fuel gas flow feed device arrangement in which the operation of the blower draws in ambient air and the flow of ambient air through the blower in turn draws fuel gas from the fuel gas flow control device, the blower mixing the ambient and fuel gas for delivery to a burner positioned to heat water in one of a cooking kettle jacket or a steam generator of a steam oven;
operating the blower at a first speed to achieve a first firing rate at the burner;
operating the blower at a second speed to achieve a second firing rate at the burner, the second speed at least twenty percent greater than the first speed;
wherein a fuel gas to ambient air ratio at the first firing rate is substantially the same as a fuel gas to ambient air ration at the second firing rate.

19. The method of claim 18 wherein the first speed is a defined burner start-up speed and the second speed is a defined full speed.

20. The method of claim 19 wherein the blower is operated at the first speed for a defined time period, after the set time period the blower speed is increased to the second speed.
